(19) United States
(12) Patent Application Publication
(10) Pub. No.: US 2006/0242249 A1
(43) Pub. Date: Oct. 26, 2006

(54) Method for the display of visual sequencing of message communications between application portlets and task page relationship information in a web-base environment

(75) Inventors: Carl Steven Swanson, Austin, TX (US); Gary Thomas Barta, Round Rock, TX (US); Eric John Fingal, Manor, TX (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(73) Assignee: International Business Machines Corporation, Armonk, NY (US)

(21) Appl. No.: 11/114,533

(22) Filed: Apr. 26, 2005

(51) Int. Cl. G06F 15/16

(52) U.S. Cl. 709/206

(57) ABSTRACT

A display portal page in a web-based environment. This display portlet presents the message communication information between the portlets that are currently running on that portal page. The displayed message communication information indicates the portlet that is the source of a transmitted message and displays one or more portlets that receive the message. The visual representations can be of various formats such as a spacial display or a tree representation. Each communicated message has a stored record identifying the transmitting portlet and any portlet that receives the message.

### FIELD OF THE INVENTION

The invention relates to the display of portlets in a web portal page and in particular to a method and system for tracking and displaying sequences of data communications between application portlets transmitting data and application portlets receiving the data.

### BACKGROUND OF THE INVENTION

As the use of the Internet becomes more pervasive, better technology is constantly being developed for displaying web content. Web portal pages have become an increasingly popular means of delivering aggregated, personalized content to computer users. A portal is a point of access to data and applications that provides a unified and personalized view of information and resources. Portals are typically implemented as websites on a worldwide communication network and are accessible via web browser applications. Portals have evolved from simple one page content sites to multi-page aggregations of content and applications with integration to back-office systems.

Typically, a portal page is rendered and delivered to a viewing user from a portal server. The portal server includes a portal program such as the commercially available WebSphere Portal Server, which is loaded on the portal server. The portal program generally obtains and aggregates web content into a portal page. As known in the art, a portal page includes sections or portlets that each contains particular web content formatted according to a user's preferences. For example, a user could establish his/her own portal page that has sections for news, weather, sports, etc. When the portal page is requested, the portal program would obtain the desired web content from the appropriate content providers. Once obtained, the portal content would be aggregated, and then displayed as a portal web page. This portal technology has lead to the explosion of personalized “home” pages for individual web users (e.g., MY.YAHOO.COM).

In particular, the emerging web desktop can provide users with access to what is commonly referred to as a portal. The portal can also allow a user to access multiple applications through a single screen (displayed by the web browser). For example, some portals allow users to access applications that can show data, such as weather, sports, stock information, or the like, to a user on a single screen. However, much of the processing required to manage the portal (such as administration, customization, and switching) can place even greater demands on the bandwidth available between the browser and the application.

Traditionally, portals can be accessed through desktop browser applications. Browsers have been referred to as “rich clients” as browsers can provide powerful rendering capabilities, including the ability to apply style sheets to content to ensure conformity in visual appearance between applications.

Portals represent a sensible solution to the problem of aggregating content through a channel paradigm in a single, network-addressable location. In consequence, portals have become the rage in content distribution.

Portlets are the visible active components included as part of portal pages. Similar to the graphical windows paradigm of windowing operating systems, each portlet in a portal occupies a portion of the portal page through which the portlet can display associated content from a portlet channel. Portlets are known to include both simple applications such as an electronic mail client, and also more complex applications such as forecasting output from a customer relationship management system. The prototypical portlet can be implemented as server-side scripts executed through a portal server.

From the end-user perspective, a portlet is a content channel or application to which the end-user can subscribe. By comparison, from the perspective of the content provider, a portlet is a means through which content can be distributed in a personalized manner to a subscribing end-user. Finally, from the point of view of the portal, a portlet merely is a component, which can be rendered within the portal page. In any case, by providing one or more individually selectable and configurable portlets in a portal, portal providers can distribute content and applications through a unified interface in a personalized manner according to the preferences of the end-user.

Developers have begun to apply the portlet technology for more commercial applications. For example, a portal page can be used to customize a page for an employee, customer, supplier, etc. In these applications, data presented in the portlets is often related. For example, data in a “destination city” field of a travel portlet could be shared with a “target city” field of a weather portlet. In current implementations, a portlet can share data with another known portlet by using messaging or passing parameters. However, the portlet developer must have detailed knowledge of all participating portlets in order to implement the data sharing. Further, the decision of whether to share data, and what data to share is fixed when a portlet is developed. These limitations restrict the reusability and interoperability of portlets.

Portal complexity has also increased due to the growth in the number of portal users. However, tools for administering portals have not kept pace with these trends. The problem addressed is in a web portal environment, with applications running with dynamic screen content and interaction. Unlike some portal applications that deliver content that changes infrequently, application interfaces in a portal deliver rapidly changing content. As an application delivers content, accepts user input, and then launches other portlets with that context and information, several different portlets tend to build up on the screen. This is as designed and what is intended, but when these portlets interact with each other, it becomes difficult to follow the chain of user interactive message transmissions from one portlet to another and from one task page to another. This becomes confusing to users and detracts from a carefully laid out and designed interface.

A method is needed then to detect data transmissions between portlets and task pages on the screen and allow a user to quickly and easily determine what transmissions are occurring between which portlets in a web-based environment.

### SUMMARY OF THE INVENTION

It is an objective of the present invention to provide a method to track and display portlet and task page data communications in a Web-based Portal environment.

It is a second objective of the present invention to provide a record containing all portlets that have transmitted data to or received data from other specific portlets in a Web-based portal environment.

It is a third objective of the present invention to provide a portlet message communication sequence display as a spacial display to a web user.

It is a fourth objective of the present invention to provide a portlet message communication sequence display in a tree representation display to a web user.

It is a fifth objective of the present invention to provide a method capable of displaying a multiple page portlet message communication sequence to a web user.

It is a sixth objective of the present invention to provide an updated visual display when a new portlet communication is established or an existing portlet communication terminates.

The main concept of the present invention is a method to display and visualize the portlet and task page message communication sequences between portlets in a Web-based portal environment. In a portal environment, some applications provide for the establishment of communications between portlets resulting directly or indirectly from user actions. These portlets also have the capability to establish communications with other portlets. What then happens is that the user may have many portlets on the screen, and no way to relate which portlets are in communication other portlets. Many times, this is important, so that the user can relate information in between those portlets, making decisions, etc.

In the method of the present invention, a launched and running portlet would be displayed to the web user. During the execution, if a portlet initiates a communication with another portlet, this communication will also be displayed showing the direction of the communication between portlets. In a spacial portlet display, an arrow or other marker can appear to indicate the data transmission from one portlet to another portlet on the web screen. The marker will display the established communications between portlets appearing in the web-based portal environment.

In an implementation of the method, a monitor detects the initiation of a communication between portlets. A record is created for that portlet communication sequence. This record contains information, which includes the identity of the portlet initiating the communication and the portlet(s) receiving the communication. The record can contain pointer fields that point to a transmitting portlet and to any receiving portlets. These records are stored such that a display routine can retrieve information from these records and display a visual presentation of the relationships of the launched portlets. The basic steps of the method of the invention include:
On initial launch of the communication display portlet, the portlet contains the any current communication connections that were statically pre-defined on that page.
On every portlet data transmission, the display portlet intercepts a signal that contains the transmitting portlet information and the destination portlet information.
This information is then processed, and displayed in the communication sequence visualization portlet.
When a portlet is closed or communication is terminated, that signal is intercepted, and the communication sequence visualization portlet is updated to remove that removed portlet.

The display can be a small portlet type ledger containing icons/windows for every currently launched portlet and any established communications between portlets. Within this ledger would be markers indicating the established communication relationships between the launched portlets.

As a result, the method of this invention presents to the user a way to distinguish, which portlets are in communications with other portlets, and how that inter-relationship exists in the portlet application.

### DESCRIPTION OF THE DRAWINGS

FIG. 1 is a conventional display of portlets on a portal page.

FIG. 2 is an illustration of a display message communications between portlets on a portal page.

FIG. 3a is an illustration of a spacial message communication sequence portlet for use in a portlet display in accordance with the present invention.

FIG. 3b is an illustration of a tree message communication sequence portlet for use in a portlet display in accordance with the present invention.

FIG. 4 is an illustration of a portlet sequence display screen using a spacial representation of the message communications between portlets.

FIG. 5 is an illustration of a portlet sequence display screen using a tree representation of the message communications between portlets.

FIG. 6 is an illustration of a portlet sequence display with multiple pages.

FIG. 7a shows a record format for capturing information about transmitted messages between portlets in accordance with the present invention.

FIGS. 7b through 7g show sample records with information about the relationship of portlets that have established message communications.

FIG. 8 is a flow diagram of the based steps in the method of the present invention.

FIG. 9 is a flow diagram of a detailed implementation of the steps to create and update a visualization portlet when new portlet message communication connections are established

FIG. 10 is a flow diagram of the steps to update a visualization portlet display when there is a termination of an established message communication connection.

FIG. 11 is an illustration of a portlet displaying both portlet launch sequence and portlet communication sequence relationships.

### DESCRIPTION OF THE INVENTION

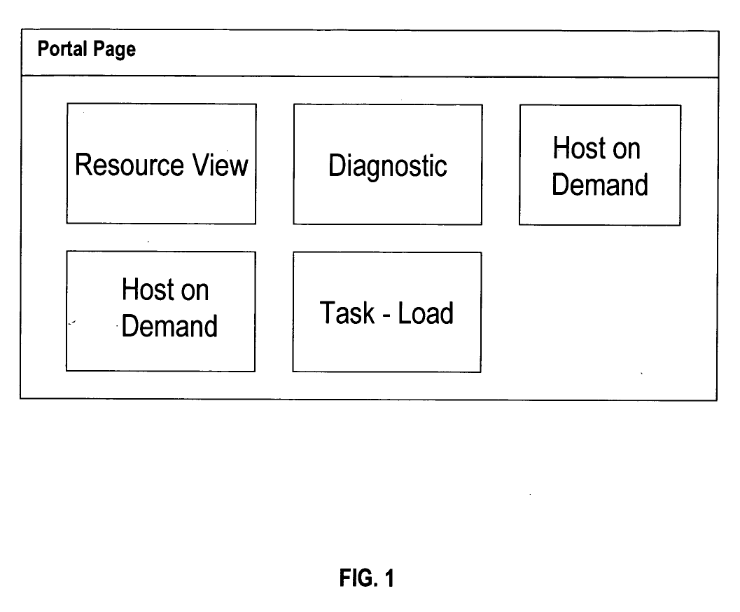

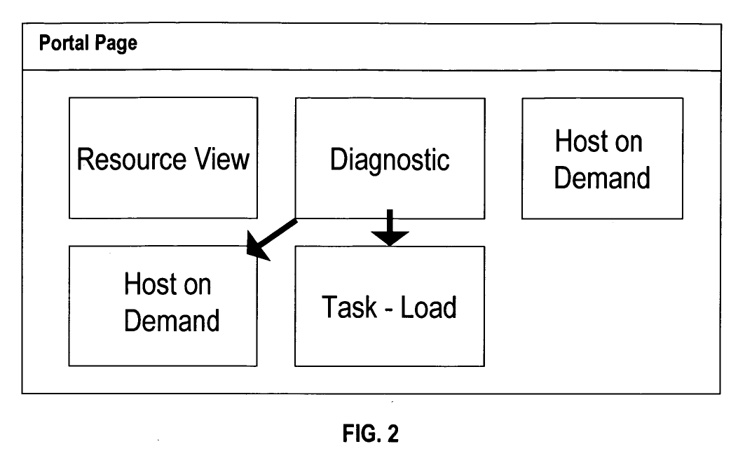

Referring to FIG. 1, shown is a display of portlets on a conventional portal web page. This portal page currently contains five portlets that perform functions related to the name of each portlet. However, conventional portal web pages contain the portlets as shown without any marker to indicate any message communication relationship between portlets. The problem with this display is that the user cannot track the message traffic between portlets in a web-based application. In FIG. 2, the arrows indicate message communication connections between the portlets. In this message communication sequence the ‘Diagnostic’ portlet has established communication with the ‘Task Load’ portlet and the ‘Host on Demand’ portlet.

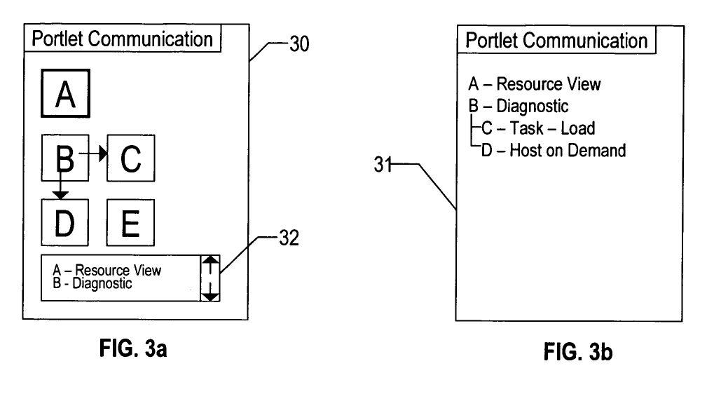

Another display representation of the relationship of the message communications between portlets could be an additional portlet on the portal page display containing the portlet message sequence information. FIGS. 3a and 3b illustrate this concept. With regard to FIGS. 3a and 3b, small message portlets 30 and 31, containing portlet message communication information, could be incorporated into this display. The message communication visualization portlet has several views/modes of displaying the message communication information. Two of the modes described herein include the spacial view and the tree view.

FIG. 3a is an illustration of a spacial message communication portlet 30 for use in a portlet display. This message communication portlet contains small icons of generic portlets with details of what portlets have established communications what other portlets. This display process also includes an algorithm that maintains proper size and spacing so that all portlets can show all relationships in the rectangular portlet space. Hover-over function allows more information on that portlet to be displayed when the mouse hovers over it.

In this display portlet 30, five portlets are currently running. From this special view, there are two established message communications. As shown, portlet ‘B’ has established communication with portlet ‘C’ and portlet ‘D’. In this portlet display, the letter designations for each portlet may be desirable and/or necessary because of the space that may be required if the actual names of the portlets was display. As a result, a ledger 32 can be included in the portlet display to identify the name/function of each portlet in the display.

The portlet message communication visualization portlet shows up in the portal browser screen. It has different display modes the user can change, is fairly small and unobtrusive, can be hidden or displayed as desired, and shows the layout of the rest of the portal task page.

FIG. 3b shows a tree representation of the portlet message communications. The tree representation shows a text that details what portlets are in communication with other portlets. This text display screen is an alternative to the multiple icon spacial approach of FIG. 3a.

For both views (spacial and tree), as the number of portlets grows beyond the ability for a user to understand the data on a single portlet screen, a scroll mechanism will expand to allow the user to access the information extending down in that portlet. This always forces the message communication portlet to be a small and unobtrusive portlet.

Some portlets are placed statically on a page at page creation and installation time, while other portlets are launched on that page due to user actions. The differences between these two types of portlets can be denoted by different colors or transparency.

The portlet has a basic layout that displays the portlet's that have been statically placed on a page, as well as those portlets launched to the page. As mentioned, the message communications between these portlets can be represented as either a visual layout, or a tree layout.

For a spacial representation:

The portlet message communications are specified using directional arrows
The portlet naming abbreviations (A, B, C, etc) are used to conserve space, but hover text and the list box at the bottom will show the mapping to the name of the portlet
   For a tree representation:
The portlet message communication relationships are specified using hierarchical tree notation, that can be manipulated, expanded, collapsed, etc.

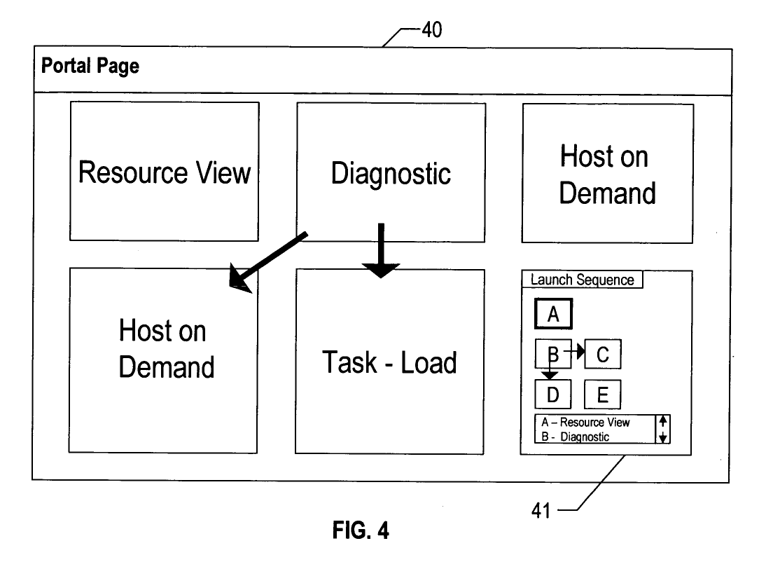

FIG. 4 is an illustration of a portlet message communication display screen using a spacial representation of the portlets. As shown, the portal page 40 has five running portlets. A sixth portlet 41 displays the message communications of the five running portlets. Also shown in this display are arrows that indicate the message communications between the actual portlets. These arrows in the actual portal page are not needed with the inclusion of the message communications display portlet 41.

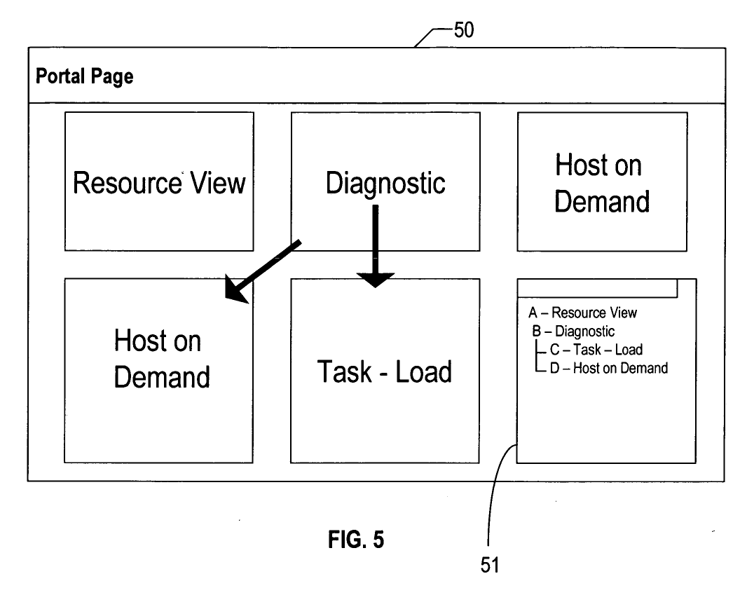

FIG. 5 is an illustration of a portlet message communications display screen using a tree representation of the displayed portlets. As with FIG. 4, the portal page 50 contains a sixth communication sequence portlet 51 that displays a tree representation of the message communication sequence of the portlets. Again, the shown arrows are not needed with the inclusion of the message communications portlet display 51.

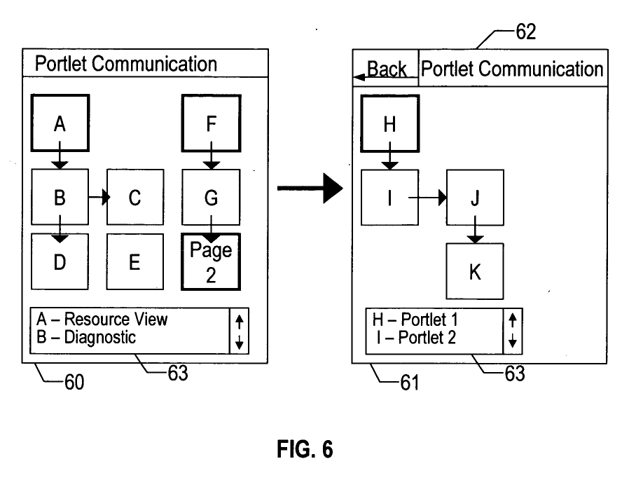

The present invention also provides a method to display the transmission of messages between portal pages. FIG. 6 is an illustration of a message communication display with multiple pages. Shown are pages 60 and 61. Also shown on page 60 are two portlet communication sequences. The first one is the previously described sequences of FIG. 2. In the second portlet communications sequence on page 60, portlet ‘F’ communicates with portlet ‘G’ which communicates with portlet ‘H’ from page 61. In this operation, the visualization portlet shows that Portlet ‘G’ on the portal page 60 has established communications with portlet H on another portal page 61. The ‘back’ button 62 enables the user to return to the initial page 60. Each page 60 and 61 also contains a ledger 63 of the portlets that are running on the page.

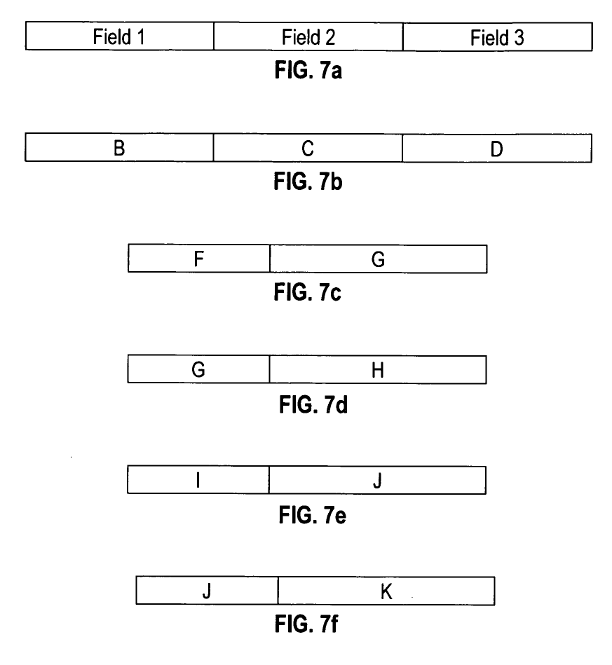

As previously mentioned, records store all messages communication connections. FIG. 7a shows a record format for capturing information about message communications between portlets. The record will comprise information identifying the message transmitting portlet, and one or more receiving portlets. This information can be arranged in the record in any arrangement desired by the system designer. In FIG. 7a, field 1 designates the portlet that initiated the present portlet communication. Field 2 contains the identity of the receiving portlet. Field 3 contains information of pointing to a second receiving portlet.

FIGS. 7b through 7g illustrate the storage of information in records in accordance with the message communications sequences of FIG. 6. Since portlets ‘A’ and ‘E’ do not currently have communications with another portlet, there is no communication record for these portlets. FIG. 7b represents the record for ‘B’ portlet. Portlet ‘B’ has communications with portlets ‘C’ and ‘D’. In FIG. 7c, Portlet ‘F’ is in communication with portlet ‘G’ FIG. 7d shows portlet ‘G’ in communication with portlet ‘H’. FIG. 7e shows portlet ‘H’ in communication with portlet ‘I’. Portal ‘I’ is in communication with portlet ‘j’ in FIG. 7e. FIG. 7g shows portlet ‘J’ in communication with portlet ‘K’. In each record, the portlet in the first field is the portlet initiating the communications.

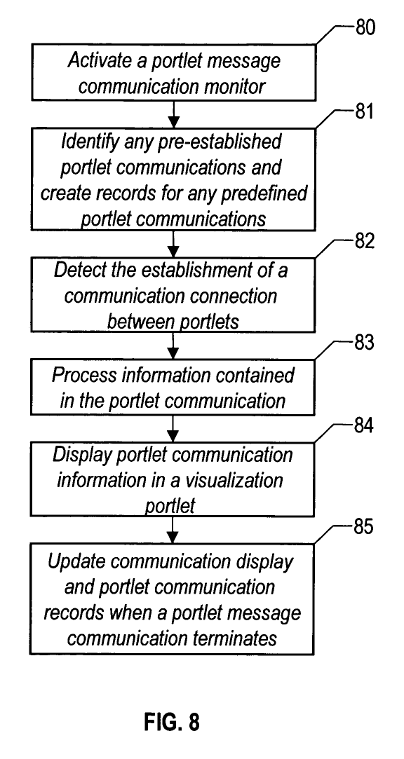

Referring to FIG. 8, shown is a flow diagram of the based steps in the method of the present invention. Initially, step 80 activates the portlet message communications monitor. This monitor is the program that monitors portlet message transmission activity and intercepts a portlet message transmission signal each time a portlet transmits a message. Step 81 accesses the portlet status at the time of the activation of the message communications monitor. This step determines and identifies any portlet communications that are running at the activation of the message communications monitor. Step 82 detects the establishment of communications between two or more portlets. The establishment of the communication could be the transmission of a message. As mentioned, when a portlet message is transmitted, the monitor detects and intercepts a signal generated by the message transmission. When this signal interception occurs, the monitor program gathers information about the transmitting portlet and the receiving portlet(s). Step 83 processes the gathered portlet information. Step 84 displays the portlet message communication information in a visualization portlet on the portal page. During the display operations of the portal page, if a portlet terminates, the message communication sequence monitor intercepts a generated termination signal or a communication disconnect. Step 85 identifies the terminated portlet and updates the message communication display to reflect the terminated portlet.

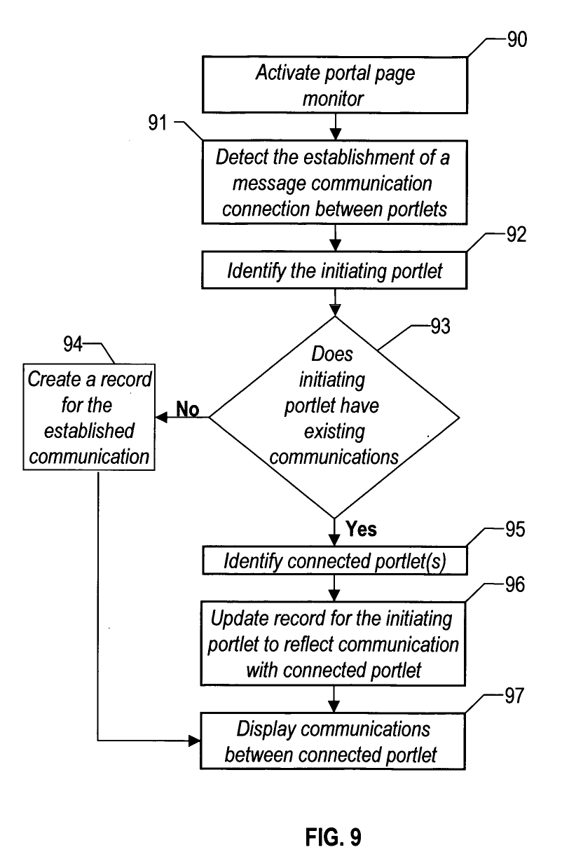

FIG. 9 shows a more detailed implementation of the steps to create and update a visualization portlet when a new portlet message transmission occurs. Step 90 activates the sequence monitor for that portal page. This monitor could be a separate program or it could a system program that will monitor the portlet message transmission activity for any portal page in the system. As part of the activation, records could be created for any communications between that existed prior to the activation of the communications monitor. Step 91 detects the establishment of a communication between portlets. As mentioned, this monitor will intercept a message communication signal each time a portlet transmits a message or a portlet terminates an established portlet communication. After the detection of a message transmission, step 92 identifies the transmitting portlet. After this identification, step 93 determines whether this portlet has transmitted messages to other portlets. In the event the transmitting/initiating portlet does not have existing transmissions, the process moves to step 94. This step creates a record for that portlet. As mentioned, the record contains fields with pointers and identifiers that define the message communication relationship of this portlet to other existing portlets in the display. At the completion of step 94, the process moves to step 97 where the display is updated to include information about the new message communication.

Referring back to step 93, if the transmitting portlet has other established communications, the process moves to step 95, which identifies established connections. At this point, step 96 updates the existing record for the transmitting portlet to include the new receiving portlet identity. The records for the launched portlets can reside in any designated memory location as desired by the system designers or users. At the completion of the record creation and record update activities, step 97 retrieves the updated record information and updates the message communication portlet display to reflect the communication changes that result from the newly initiated message communications.

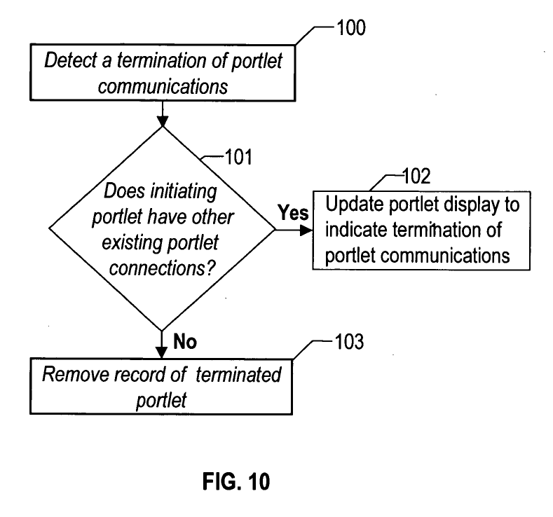

When a running portlet terminates communications with a connected portlet, it is necessary to update the message communication portlet display. FIG. 10 illustrates the steps to update a visualization portlet display when a displayed portlet terminates communications. Step 100 detects the termination of a portlet communication connection. After the detection of the terminated connection, step 101 determines whether the initiating portlet has established communications with other portlets. If the initiating portlet does not have any other established communications, step 103 removes the record of the terminated portlet communication connection. If the initiating portlet does have other established connections, step 102 updates the record for the initiating portlet to remove the indication of a connection to the portlet of which the terminated connection was established.

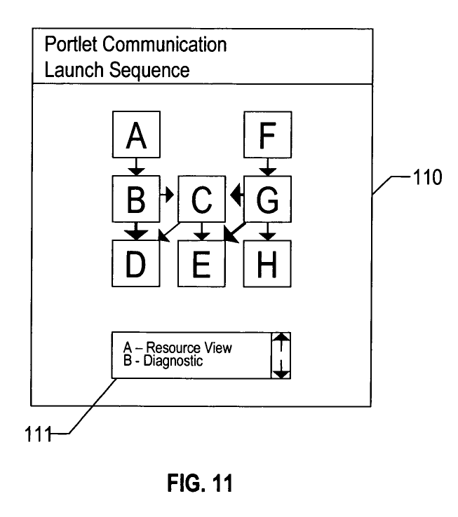

FIG. 11 is an illustration of a portlet displaying both portlet launch sequence and portlet communication sequence relationships. This display combines technology from the present invention with the methods for displaying portlet launch sequence information described in a co-pending patent application to the same inventors. As shown, the portlet 110 contains icons for eight portlets. This portlet display is in a special format and contains two sets of arrows. Noticeably thick arrows indicate established communications between portlets. The thin arrows indicate portlet launch sequences. The display indicates two portlet launch sequences. As shown, portlet ‘A’ launched portlet ‘B’ which launched portlet ‘C’. Portlet ‘C’ launches portlets ‘D’ and ‘E’. In the second launch sequence, portlet ‘F’ launches portlet ‘G’ which launches portlet ‘H’.

The displayed communication sequence shows message communications between portlets in the same launch sequence and portlets of different launch sequences. As shown, portlet ‘B’ has established communication with portlet ‘D’. Portlet ‘G’ from the second portlet launch sequence has established communications with portlets ‘C’ and ‘E’ of the first portlet launch sequence. In operation, as the user interacts with portlet ‘G’ and messages get sent to portlets ‘C’ and ‘E’, the system intercepts the transmitted message and displays it on the portlet sequence display. As with the other embodiments, ledger 111 indicates all of the portlets that are running on the page. The display arrows for both launch and display sequences can be represented in various formats. For example, one set of arrows could be dotted while the other set of arrows could be solid in order to distinguish the arrow sets. In addition, other display formats such the tree format can be used to represent this combined launch sequence and message communication display. Another alternative could be separate portlets for displaying the portlet launch sequences as indicated in the previously mentioned co-pending application and the communication portlet described herein.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy and transmission-type of media, such as digital and analog communications links.

We claim:

1. A method for displaying message communication information between portlets activated in a Web-base environment comprising the steps of:
detecting the establishment of a communication connection between portlets;
processing information contained in the detected portlet communication; and
displaying a portlet message communication between portlets, the display being based on portlet communication connection information including an identification of a portlet initiating the communication connection and a portlet with which communications were established.

2. The method as described in claim 1 further comprising before said detecting step the steps of:
activating a portlet message communication monitoring program; and
determining a current communication status of any portlets that are active at the time of the activation of the portlet message communication-monitoring program.

3. The method as described in claim 2 wherein said information processing step further comprises creating a record for a newly established portlet communication connection, the record comprising two or more fields which can contain information about the identity of the portlet initiating the communication connection and the one or portlets to which the communication was established.

4. The method as described in claim 3 wherein a field of a record for a newly established communication connection contains a pointer to a portlet that initiated the newly established communication connection.

5. The method as described in claim 1 further comprising after said displaying step, the steps of:
detecting the termination of an established communication connection;
removing the visual display of the terminated communication connection; and
updating a portlet record of the portlet that initiated the communication connection.

6. The method as described in claim 5 wherein said portlet record updating step further comprises removing a record of the portlet that originally initiated the newly terminated portlet.

7. The method as described in claim 1 wherein the portlet message communication display is a spacial display. .

8. The method as described in claim 1 wherein the portlet message communication display is a tree presentation display.

9. The method as described in claim 1 wherein the portlet message communication display is a multiple page display.

10. The method as described in claim 1 further comprising the steps of:
identifying a message transmitting portlet and a message receiving for detected message transmissions and identifying a launched portlet and a launching portlet for detected portlet launching activities.
creating records for the newly established communication connection and for creating newly launched portlet; and
displaying the message communication and portlet launch communication formation in a display portlet.

11. The method as described in claim 10 wherein said record creating step further comprises creating a record for a newly established portlet communication connection, the record comprising two or more fields which can contain information about the identity of the portlet initiating the communication connection and the one or portlets to which the communication was established.

12. The method as described in claim 10 wherein said record creating step further comprises creating a record for a newly launched portlet, the record comprising two or more fields which can contain information about the origin of a launched portlet, the identity of the launched portlet and any other portlets launched by the portlet.

13. The method as described in claim 10 further comprising the steps of:
detecting the termination of an established communication connection;
removing the visual display of the terminated communication connection; and
updating a portlet record of the portlet that initiated the communication connection.

14. The method as described in claim 10 further comprising the steps of:
detecting the termination of an active portlet;
removing the record and visual display of the terminated portlet;
updating portlet records related to the terminated portlet; and
displaying a modified portlet launch sequence.

15. A computer program product in a computer readable medium for displaying message communication information between portlets activated in a Web-base environment comprising:
instructions for detecting the establishment of a communication connection between portlets;
instructions for processing information contained in the detected portlet communication; and
instructions for displaying a portlet message communications between portlets the display being based on portlet communication connection information including an identification of a portlet initiating the communication connection and a portlet with which communications were established.

16. The computer program product as described in claim 15 further comprising before said detecting instructions:
instructions for activating a portlet message communication monitoring program; and
instructions for determining a current communication status of any portlets that are active at the time of the activation of the portlet message communication-monitoring program.

17. The computer program product as described in claim 16 wherein said information processing instructions further comprise instructions for creating a record for a newly established portlet communication connection, the record comprising two or more fields which can contain information about the identity of the portlet initiating the communication connection and the one or portlets to which the communication was established.

18. The computer program product as described in claim 15 further comprising after said displaying instructions:
instructions for detecting the termination of an established communication connection;
instructions for removing the visual display of the terminated communication connection; and
instructions for updating a portlet record of the portlet that initiated the communication connection.

19. The computer program product as described in claim 18 wherein said portlet record updating instructions further comprise instructions for removing a record of the portlet that originally initiated the newly terminated portlet.

20. A system for displaying information related to activity between portlets activated in a Web-base environment comprising:
a user interface device having the capability to display on a display screen information on message communications between portlets;
a computer program product for displaying portlet message communication information of activated portlets on the display screen;
a network interface device for establishing communications between said user interface device and a communication network; and
a storage location for storing records of portlets that have established communications with other portlets being displayed, a record containing fields with information on a portlet that has initiated a message communication and all active portlets of which the portlet initiating the message has established communications.
